(19) United States
(12) Patent Application Publication
(10) Pub. No.: US 2013/0061288 A1
(43) Pub. Date: Mar. 7, 2013

(54) METHOD FOR CONTROLLING TRUST AND CONFIDENTIALITY IN DAILY TRANSACTIONS OF THE DIGITAL ENVIRONMENT

(71) Applicant: SERGIO GARCIA PAIM, UBERLANDIA (BR)

(72) Inventor: SERGIO GARCIA PAIM, UBERLANDIA (BR)

(73) Assignee: INVIT INFORMATION SERVICES LTDA, UBERLANDIA (BR)

(21) Appl. No.: 13/225,655

(22) Filed: Sep. 6, 2011

(51) Int. Cl. H04L 9/32

(52) U.S. Cl. 726/4

(57) ABSTRACT

The invention comprises a method for controlling trust and confidentiality during pervasive computing transactions supporting users' daily activities.

More specifically, the present invention can be regarded as a new approach for providing users with a digital environment for performing personal, business and public routine tasks in collaboration with others, yet preserving the various levels of control existing in conventional human-to-human transactions.

### TECHNICAL FIELD

The invention comprises a method for controlling trust and confidentiality during digital transactions supporting users' daily activities. The present invention relates to the field of pervasive computing (or so called ubiquitous computing) and deals with trust and confidentiality among users, organizations and software solutions. More specifically, the present invention can be regarded as a new approach for providing users with a digital environment for performing personal, business and public routine tasks in collaboration with others, yet preserving the various levels of control existing in conventional human-to-human transactions.

### BACKGROUND OF THE INVENTION

Nowadays, a broad range of services are available to users all around the world through mobile applications and Web services on top of social networks, such as Facebook, Twitter, among others. Those convenient services are now possible thanks to the ubiquity of mobile devices and Internet connection, as well as the digital representation of relevant relationships between people and the capture of their routine activities.

Nevertheless, there is a huge gap to be fulfilled which is essential for offering of a new class of services in a trusty and confidential manner. Such services require a profound control of audience, information sharing, identity and reputation. They also demand seamless integration of public, personal and professional facets a user has, so that no island of information is built, as well as convenience and control are taken to a whole new level.

In the recent years, the advent of social network websites such as Facebook meant a disruptive way of building and offering digital services having the user and his relationships as the center for value generation and usability design. Despite its great success, Facebook does not deal with those relationships in a way so as to capture and represent the intrinsic and subtle differences of their use in daily life. One aspect of such Facebook's weakness has recently been explored by Google with its new social network initiative Google+, more specifically, with Google+ Circles feature.

We are now undergoing the early days of the digital social integration and, being it Facebook, Twitter, LinkedIn or other, those are services that came up from the social graph itself. Google+ is the first initiative to build common services using the social graph as a means, not as an end. However, Google has not yet satisfied by far the need of control in digital life as the present invention does.

Such fundamental accomplishment would come from (a vision of) pervasive omnipresent services that can enter and serve a user's life at such a deep level that those control concerns would be both apparent and treatable. No solution or service nowadays has either the motive or the opportunity to fulfill that. Nonetheless, the present invention has them both as it is related to the invention “Method for using Smartphones as Public and Personal Security Devices based on Trusted Social Networks” described by the patent application U.S. Ser. No. 13/208,710, filed on Aug. 12, 2011, by Sergio Paim et al and which is herein incorporated by reference in its entirety.

The services existing today control audience and information sharing basically in a content management manner, that is, based on the static audience-and-sharing attributes of a given content (information). Those static controls are well tailored for social networks (e.g. who can see the uploaded photo) and corporate portals (e.g. who can access the new product's specifications) but not for dynamic, one-time, on-the-go daily transactions (e.g. which cab can now see my location and destination in order to pick me up).

Current location-aware social networks such as Google Latitude and Foursquare fall short regarding the control of dynamic, sensitive and live information about their users. Latitude, for instance, is a you-all-see-me solution for general purpose with elementary and non-convenient privacy and audience control.

Foursquare, on the other hand, being able neither to properly and contextually manage user's sensitive information nor to propose itself as a valuable omnipresent service, resigns to ask the user to explicitly tell where he is (to do a check-in) every time he thinks convenient.

Even conventional access controls available in corporate portals and systems (controls which are meant for business transactions and thus treat some of the dynamic aspects of the information) are not enough to these new pervasive services since a centralized and static access control is not practical or effective outside corporate environments.

Likewise, the identity management resources currently consider either corporate environments or digital social environments (i.e. social networks), wherein the digital identities are granted from formal links, in the first case (e.g. employment relationships) or, in the second case, are doubtable characters that rarely matches the real ones. Despite that, those mechanisms are well suited for their intended environments which offer no greater concerns. For instance, no harm to general Twitter's users could come from a false profile of a celebrity. For that matter, Twitter has the Verified Account feature that is indeed for backing the celebrity. But this is a kind of identity endorsement that is not capable of handling masses of ordinary users.

On the other hand, private and public certification services have always treated this matter as a business by itself. The problem, of course, is both: the capacity of certifying the masses feeding the viral dissemination potential of social-enabled pervasive services; and the difficulty of capturing the dynamic identity attributes a person has (other than his name, address and SSN—his actual and up-to-date reputation) from a centralized approach.

Consequently, the identity certification business is a small domain by itself and must be complemented by further social and decentralized mechanisms. Such complementation should follow the way social networks do their identity management (for their specific needs), but should also consider the continuing match between digital (virtual) and real identities that would happen during transactions of pervasive services for daily needs. The present invention enters the above stated problem space firstly considering that any person has a three-axis scope of transactions for personal, business/professional and public matters.

### SUMMARY OF THE INVENTION

The present invention provides a method for controlling trust and confidentiality in daily transactions of the digital environment, considering that any person has a three-axis scope of transactions for personal, business/professional and public matters. It also ponders that those transaction types are somehow interchanged in user's daily routines so a convenient and reliable type switch must be feasible regardless the specific transaction providers and hopefully without the close attention of the user.

Thanks to this integrated three-axis scope, the present invention can handle the subtle and incremental variations of trust and confidentiality need a certain user has, while performing a specific transaction with a particular group of people and services.

The present invention comprises a way of building and respecting personal digital reputation so that even a person with no professional or business interest would care for the same in order to participate in the trusted environment. This digital environment natively considers the chain of trust among companies, customers, employers, employees, professionals, citizens, public services, and others, as well as third-party software solutions so as to forwardly and backwardly propagate trust and confidentiality.

Finally, the present invention treats the user's privacy as a central point for controlling his integration into the digital social environment, thus positioning itself as a trusted intervenient for the user in front of others. This allows a new class of digital collaborations between people in many daily scenarios. Additionally, the present invention offers an outstanding way of coordinating business, personal or public meetings (and transactions) in real-time.

Therefore, the present invention comprises a method for fundamentally dealing with the problems that arise when some internal business process must be done in collaboration with people outside the company including, of course, its customers.

Inversely, the present invention also includes a method for dealing with the problems that arise when the user leaves his private and dosed environment in order to digitally collaborate with people and organizations that provide him services.

Last of all, the present invention is a means for providing individuals and organizations with a bi-directional channel with the open community—a channel that is sometimes identified, sometimes anonymous, and, yet, is always reliable and confidential.

### Technical/Functional Advantages

Trust and confidentiality intermediation: the present invention offers to users, companies and public/community organizations a trusted and confidential channel for bi-directional transacting between them all based on an explicit, manageable and transparent chain of trust;
Solidary personal reputation: the present invention has a matchless mechanism for improving the value of an individual's digital reputation, a method that uses his small and closest graph of trusted people as his supportive and co-responsible certification entity;
Activity-based visibility control: the present invention provides the users with an implicit way to control whether he is visible to others based on the actual activities (and corresponding states) he is performing;
Privacy control: the present invention offers the user a private state that has primacy over any other said activity (and states) which, in turn, allows him to be consciously in control of his privacy whenever needed;
Real-time meeting coordination: the present invention has a distinctive functionality for the user in order to provide him with real-time location-aware coordination of meetings, being them for professional, personal or public purposes.

### BRIEF DESCRIPTION OF THE DRAWINGS

The present invention will be readily understood by the following detailed description in conjunction with the accompanying drawings, wherein like reference underscored numerals designate like structural and/or behavioral elements of the invention, and in which:

FIG. 1 depicts a schematic scope of a person's daily digital transactions considering a pervasive computing environment, as well as three axes representing personal, professional (business) and public transaction types.

FIGS. 2A, 2B, 2C and 2D depict archetypal scenarios a given personal would have considering the transaction types depicted in FIG. 1.

FIG. 3 depicts a method for building, promoting and using the individual reputation of a user, considering a small but cohesive group of people that trust him.

FIG. 4 depicts a sample chain of trust between individuals and organizations in order to illustrate the applicable scenarios of pervasive computing only possible on top a trusted digital social environment.

FIG. 5 depicts a method for giving to user's privacy primacy over any other demand inside the trusted digital social environment on top of an activity-based visibility control.

FIG. 6 depicts a functionality resource for real-time coordination of meetings between users for personal, professional or public interests.

### DESCRIPTION OF THE PREFERABLE EMBODIMENTS OF THE INVENTION

As noted above, properly handling the problems that arise from pervasive computing scenarios, which serve larger and larger portions of a user's daily routine is yet an untapped field.

Accordingly, the present invention provides techniques, methods and functionalities that allow users to transact with others in a trusted and confidential manner, attempting as much as possible to reassemble, in the digital environment, the means available in the real world.

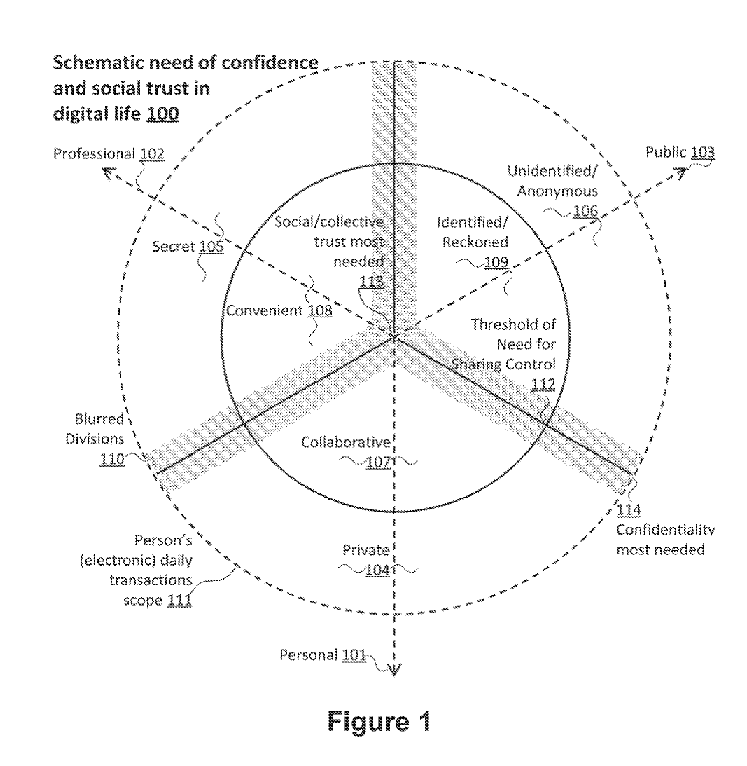

Embodiments of the main aspects of the present invention can be appreciated by the discussion below with reference to FIG. 1 and then to the remaining figures. However, those skilled in the art will promptly appreciate that the detailed description given herein with respect to these figures is for explanatory purposes only, as the present invention extends beyond these limited embodiments.

FIG. 1 depicts a schematic digital transaction scope a user can have during a day 111, for the purpose of illustrating the various different needs of confidence and trust 100 a pervasive computing environment must address. This scope is divided into three axes, each one considering the driving force of transactions, that is, their main purpose and subject, namely: personal 101, professional 102 and public 103.

Personal transactions 101 are those a user does on his very interest and resources, for example: watching TV, surfing the Web, traveling for tourism, shopping in a mall, having dinner at home or in a restaurant, among others.

Professional transactions 102 are those a user does while making a living and, so, most of the time they are more formally prescribed and controlled, as well as they are likely done on behalf of a bigger group (i.e. the company). Examples can be: registering an invoice, forecasting sales, delivering goods to clients, supporting customers, etc.

Public transactions 103, in turn, are those a user does while contributing with the general public for specific topics and interests, for example: posting in a blog, rating a service or place, Facebook-liking something on the Web, making a complaint, donating to an NGO, etc.

Note that the divisions between those three types are often blurred 110 because, from the pervasive computing environment perspective, it is very hard to know exactly whether the user has started or stopped working or whether he wants to open up his information to public or remain closed. Actually, a user may be doing transactions of the three types at the same time, which makes it hard to differentiate them.

But the central argument of FIG. 1 is that nowadays this transaction scope 111 is not properly and seamlessly handled. Today, there are many professional islands in every big or small company and, even those companies being connected to the Web via portals, only a small subset of all possible business transactions are actually integrated into the Web. This is a classical corporate issue (i.e. EAI—Enterprise Application Integration) and, as it stands, it is far from being capable of integrating companies into the coming pervasive computing world. For example, how can a company externalize a field sales process to its customers in order to show them where the salesman is and how long he is taking to arrive at client's place yet preserving the salesman's privacy when he is not working? Which part of the process must remain closed in order to define SLAs (Service Level Agreements)?

The same happens inside private places and devices (e.g. homes, cars, PCs, smartphones, etc.). Just a small subset of all personal transactions is properly handled, since most of the time those transactions are either poor automated (e.g. a user searches for the nearest pizza restaurant) or served by offline services (e.g. watching a movie on a cable TV, or finding a route in a car GPS). So, up to now, no greater problems and solutions have occurred regarding the personal aspects of a pervasive computing world.

Illustrating this point with science fiction, despite all the appeal and usefulness of an omnipresent digital assistant such as Iron Man's JARVIS, without proper control, every person could actually know who was with Tony Stark in his bedroom the night before. Considering that we all will soon experience similar Domotics scenarios with TVs, refrigerators, washing machines, etc.—all connected to the Web, a great number of new personal transactions must be controlled.

Evidently, the public transactions are presently the better controlled type. This is because the majority of sites (and applications) that deal with them is user centric (especially, social networks), thus treating all the ordinary aspects of public flow of information. Nonetheless, those sites (and their controls) stop being effective when dealing with more serious matter such as public security—as done by the invention described in the application U.S. Ser. No. 13/208,710. For instance, the use of Twitter for notifications of catastrophes and/or threats is potentially harmful, since, during a crisis, many uncertified, untrusted messages could lead to general panic—only with truly reckoned users 109 such misuse can be avoided. Another example is the guarantee of anonymity 106 a public service must give to any witness calling a hotline—it is hard for any frightened witness to trust an unknown person on the other side of the line (or the Web).

Those sites and applications are neither well suited even for non-threatening but trust-needed scenarios. Consider the simple survey of costumers' opinion in an e-commerce site. How to reprehend bad behavior of a commenting costumer who is actually a false profile? How can the site bind that profile to the person who bought its products and services 109, preventing him from building up another profile later? How can a customer truthfully criticize a had product, anonymously 106 yet trustily?

The key to all said questions is a unified view of the daily routine of the user, being it for professional, personal or public affairs. It is much simpler, though, to handle those three aspects disjointedly and, actually, this is what is being currently done. Of course, this limits so much the automation possibilities.

Today, the companies treat most business activities as secret 105, that is, as internal business activities that are kept almost totally inside the companies' Intranets, with minimal interaction with external stakeholders (except by the activities the actual stakeholders perform). All business activities that could be done in real-time coordination with customers and partners 108, in order to improve their convenience, are still to be exposed and properly managed.

As above stated, the personal life automation is still under development and does need considerable improvements and most of the time all transactions are simply treated as private 104. All great scenarios from the collaborative aspects of a personal life 107 are yet to be explored. Most of the convenient services a person or company would offer to its consumers would be provided by convenient professional transactions 108 for the server person and received by collaborative personal transactions 107 for the customer. For instance, a customer would share his real-time location with a salesperson only during the sale transaction—the nearest salesperson to the customer when he first looked for one. Another example is calling a cab, as above mentioned.

The current sites and applications that offer consumer services treat personal affairs either from the professional/business perspective 102 or from the public one 103. In the first case, they offer consumers a central point of control (a user ID and a portal/application) as if they were members of the company in a secret transaction 105—there is no integration whatsoever into the consumers' life (and maybe those services do not have the right or premise to do that). In the second case, the general approach is to treat those personal transactions as identified public 109 when there are no privacy concerns or as anonymous public 106 when that is the case—in neither situation the personal potential scenarios are explored as they could be. For instance, that is probably the main condition denying Foursquare to set aside its Check-in feature and adequately knowing where its users are and whether and to whom publish their location.

If current solutions treat the three aspects separately, the challenge is to integrate them. And such integration would best follow the convergence of them all. FIG. 1 also illustrates that, going from the outer border 114 to the center 113, there is an arbitrary moment when the control of sharing becomes critical 112. That is the point where most of current solutions fall short. For instance, the on-off button for sharing your location inside a twit is actually the point where Twitter faces its confidentiality threshold 112—and that on-off button is its best shot.

Not being able of seamlessly handling such variation of control, current solutions never surpass the tradeoff between confidentiality 114 and trust 113 (i.e. for me to trust you, I have to know you; if I do not know you, I do not trust you). That is why the present invention provides a way to boost trust inside the digital environment, as well as proposes itself as an intermediate for the users' trust and confidentiality. Once again, the present invention is for the maximization of the applicable pervasive computing scenarios—the ones that can be found in the entire transaction scope 111, but especially the nowadays almost unexplored scenarios of professional convenience 108, personal collaboration 107 and online services for private personal use 104.

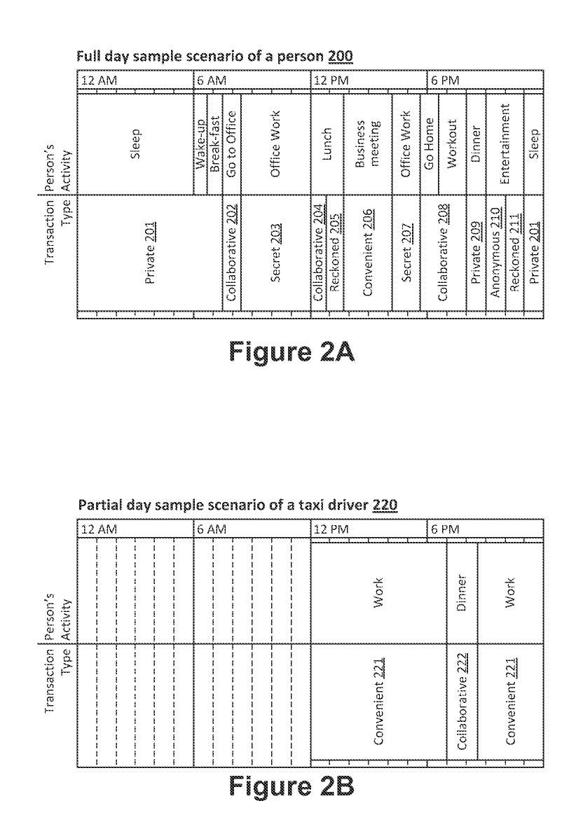

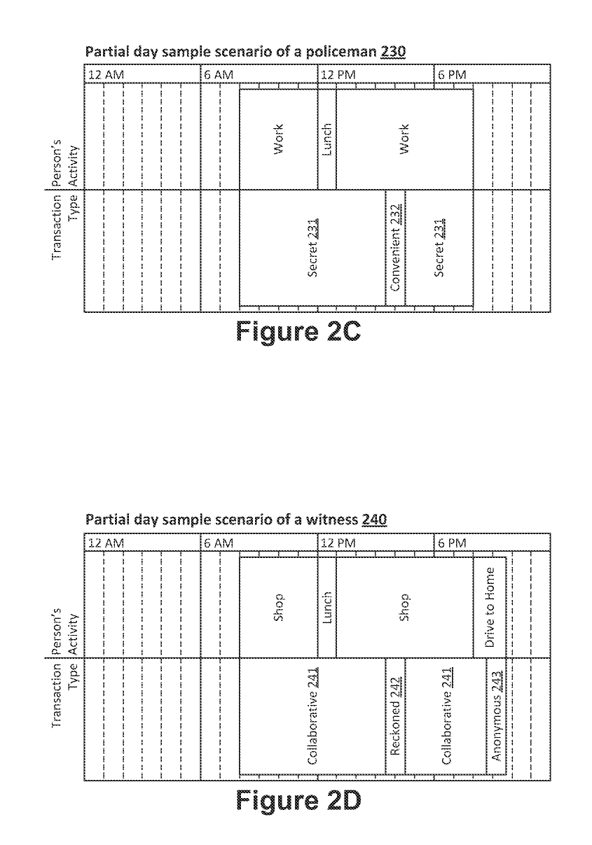

FIG. 2A depicts an archetypal routine of a person 200 in order to illustrate the interchangeability of transaction types that happens during a day as he performs his ordinary tasks. His day starts private 201 after a night's sleep as he wakes up and has breakfast. Then, it turns into collaborative 202 when he is going to office, meaning that in this activity he could be collaborating with convenient services from third-party providers, such as cabs. When he starts working, he remains secret 203 due to internal work tasks that morning.

During lunch time, he first changes to collaborative 204 in order to set up and coordinate a lunch meeting with his friends nearby and, after arriving at the restaurant, he turns into reckoned/identified 205 so as to participate in the public conveniences offered therein—he does an automatic check-in in the place, for example. He returns to work that afternoon, while visiting company's clients in a convenient 206 way for them (i.e. sharing sensitive information and, thus, allowing real-time coordination and other transactions with them). After those meetings, he gets back to office so as to finish his “paper work” secretly 207.

He becomes collaborative again 208 when he goes home by taxi and then starts working-out with his personal trainer (maybe jogging with him collaboratively). Then he has dinner privately 209 and, after that, starts to entertain himself anonymously 210 on TV and Web, until he signs-in in a social network for updating his status 211.

FIG. 2B depicts a sample scenario of a taxi driver 220, possibly the one who took the person of FIG. 2A to home after work. After common personal daily activities, he starts working in a convenient manner 221 for his potential passengers, only stopping to be visible to them at the time he is having dinner. During that, he is actually the one receiving convenient services as he turns into collaborative 222.

FIG. 2C depicts a sample scenario of a policeman 230, which is probably the profession more likely to have sensitive and secret information 231. Despite that, in scenarios of public security, including crimes scenes such as stated in said related application U.S. Ser. No. 13/208,710, it is of great value the real-time sharing of policeman's status conveniently to victims and witnesses 232. Conversely, a witness would essentially have similar concerns 204 as depicted in FIG. 2D. During a whole day of collaborative 241 shopping, he eyewitnesses an arm robbery or somebody having a heart attack. In order to help, he makes a public trusted and reckoned notification 242 for calling police or ambulance, respectively. At the end of the day, while he is driving to home, he notices that his neighbor is doing something weird and suspicious and, even though willing to make a valuable anonymous denunciation 243, he would not do that unless assured that his identity would not be disclosed—even to public officials.

Note that in organized crime scenarios (especially the ones that happen in poor and/or underserved places and countries) a potential witness would never do a denunciation if he had a minimal doubt on the corruptive power of the criminals on public services and officials. So, having a confidentiality and trust intermediate such as proposed by the present invention is mandatory in any critical scenario of public interest.

Regarding trust and identity management, in public transactions, ordinary individuals, unlike organizations and professionals, do not have an intrinsic and strong motive to care about their digital reputation and identities. Of course, regarding criminal acts such as pedophilia and cybercrime, such digital identities would ultimately lead to the real persons, but those are particular cases in which the severity normally compensates the costs of verification and investigation.

On a lower yet relevant severity cases, such as hoax hotline calls or false alerts to general population, it is very hard to track and reprehend the real persons, despite the public harm caused by them. Actually, the major damage is that the channel for social responsiveness becomes compromised and discredited. Lastly, it is practically impossible to avoid the proliferation of false identities and profiles in general web services.

Accordingly, the first underpinning concept of the present invention for building trust of individuals is to consider the integration of the three aspects a person can have, while transacting with others (personally, professionally and publicly as above stated). Considering the main technical field of the present invention, that is pervasive computing, we are now entering the age of the definitive junction of the two environments, virtual-digital and real-physical. And this adds greatly to the purpose of building personal trust and reputation. Unlike in pure virtual environments, a user in a full-fledged pervasive environment would ultimately have to regularly be face-to-face with others and, thus, be willing to get himself checked and rated. If he rather refuses it, he is actually limiting so much the scenarios (personal, professional or public) he could benefit from. The way the present invention explores this concept is detailed below. For now, it helps contextualize the benefit of the second underpinning concept for building trust of individuals: solidary reputation.

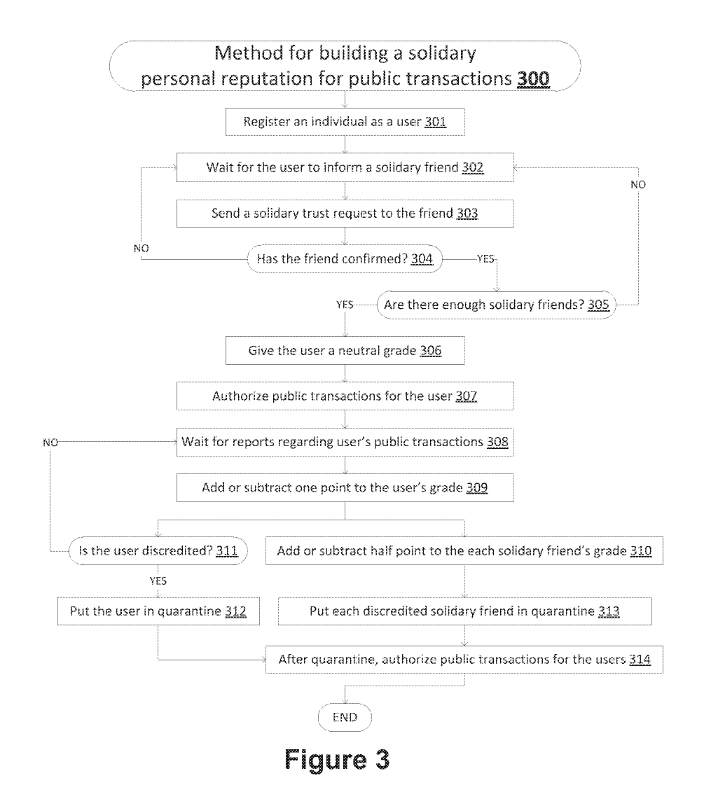

FIG. 3 depicts a method 300 for building a solidary personal reputation for public transactions, which is mainly automated by web services.

Considering said first concept, the more integrated said three aspects are for the user, the harder is for him to abandon his digital identity and reputation—especially considering the benefits of solutions, such as for personal physical protection as stated in said related application U.S. Ser. No. 13/208,710. Method 300 leverages this by putting small groups of trusted friends in a partially shared reputation agreement. The same thing that makes bullies even more overbearing when in group makes then weak and humble when observed and caught together. Bad behavior is unlikely to happen among groups of identified persons. People tend to openly congregate so as to address ethical issues and the collective good.

For that matter, method 300 starts registering a person as a user 301 and waits for him to set up a group of solidary trusted friends 302 through solidary trust requests 303. Note that the trust link is reciprocal and so the request must be approved by the trusted friend 304. After a given number (e.g. five) of trusted friends has being linked 305, the present invention gives the user a neutral grade 306, that is, a number of points (e.g. six) that represents an initial basic trust in the user yet allowing him to do public transactions (both above stated reckoned and anonymous) in the digital environment 307.

Contrasting professional and personal transactions (where the information sharing is constricted to the participants of the transaction and the outcomes are directly and immediately resolved), public transactions are basically for a wide audience and can live for long periods of time. For example, when a user takes a taxi ride and then rates it, the professional and personal transactions (i.e. the taxi driver's convenient transaction and the user's collaborative one) are finished and resolved just after that ride; the rate (reckoned or anonymous), however, will live maybe for years and be accessible to whoever looks for that cab.

So, being it anonymous or not, every public transaction could be an abuse and the very community must be able to control it. For giving the society such control, method 300 waits for reports regarding user's public transactions 308. Such reports are also public transactions and thus are only done by trusted people too (but not the ones trusted by the user). Note that reports can be either negative (an abuse) or positive (a good act such as a helpful witnessing) and are the summary of several reports a public transaction can receive (i.e. one transaction will be onetime reported negative or positive if one or more trusted users report it good or bad). Consequently, the same public transaction can be reported both positive and negative.

After each report, the present invention adds or subtracts one point to the user's current grade 309, depending on the type of report, respectively positive or negative. If the new grade is bigger than a given number of points (e.g. ten) then the new grade is defined as this number (in such example, ten). If the new grade is lower than a given number of points (e.g. one), then the new grade is defined as this number (in such example, one).

The present invention does a similar grade (as in 309) for each trusted solidary friend of the user, but instead of one point downgrade or upgrade, it considers only half point variation to each solidary friend's new grade 310.

Having calculated the new grades for each user in the shared reputation agreement, the present invention then compares them all with a giving general threshold, that is, a minimal number of grade points (e.g. five) below which any user is considered discredited. Being so 311, the present invention puts the user in quarantine 312 meaning that he will remain prohibited from doing public transactions inside the trusted digital environment for a giving period of time (e.g. one month). The same procedure is done with each solidary friend whose grade also became lower than said threshold 313.

After said quarantine period of time, the blocked users' grades are raised back to said threshold number of points (in such example, five) allowing those users to public transact again 314.

The clear intent of such mechanism is to have real persons tracking and reprehending a real person that is known and trusted by them. So just after a user has abused the public environment their friends would either censure his behavior or leave the shared reputation agreement with him. In both ways the user will likely stop abusing.

As above stated, a fundamental concept of the present invention is the actual integration of the three aspects (personal, professional and public) a person can have while transacting with others. In order to do that, it first offers a distinct environment for treating each aspect, that is, one for individuals, one for businesses and one for public interests (treated anonymously or in a reckoned manner). Being first treated in completely separated environments, the three aspects can then be properly integrated through a trust chain among the specific participants of such transactions.

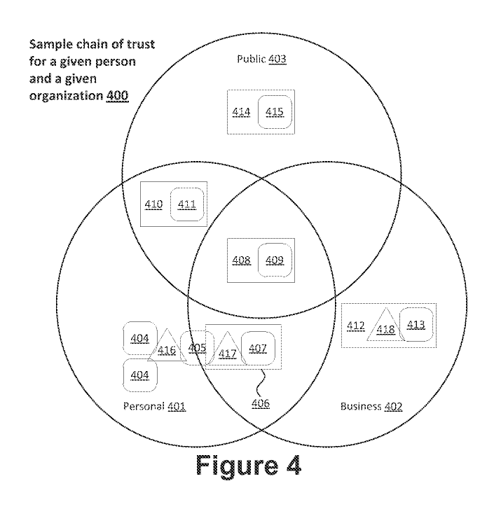

FIG. 4 depicts a schema representing a typical chain of trust that a given person and a given organization can have 400 so as to illustrate how the present invention can set up a chain of trust (and confidentiality) crossing disparate, even conflicting aspects and yet integrating them.

First the three distinct environments are logically represented as interconnected circles, namely personal 401, business 402 and public 403. The first two, 401 and 402, represent the instances of the particular environments of a given person and of a given organization, respectively. The last one 403 represents the unique public environment instance shared by everybody.

From the given person's perspective 405, it is depicted that he has two friends 404 plus himself 405 in a shared reputation agreement, as above stated. He also works in the company 406, which means that he has trusted it in the digital environment. Working in said company also means that he also has a basic yet professional trust relationship with its other employee 407.

He also trusts two organizations: organization 408 is the emergency service of local city which has a public channel inside the digital environment. In this sample, it has been trusted by person 405 and, doing so, he also trusts the official 409 responsible for answering the calls. Organization 410 is actually a private protection firm who provides paid services to individuals and organizations and also has a public channel inside the digital environment. The person 405 trusts it and consequently trusts its attendant 411.

From the given organization's perspective 406, it is depicted that it has two employees 405 and 407 and also trusts the local emergency services 408 and its official 409. Said company 406 trusts a delivery company 412 and its deliveryman 413 in order to digitally transact with them in a trusted and confidential fashion.

In the digital environment there is another organization 414 which is, for example, a NGO for bullying prevention that also has a public channel in the public environment 403 (with a dedicated attendant 415). However, presently, it has been trusted by neither person 405 nor said organization 406.

Finally, in order to complete the chain of trust, it is mandatory to consider the actual software services and applications that make use of it. For personal purposes, the software solution 416 uses the trust relationship between person 405 and his friends 404 so as to share between them their live status (including their location) and then provide, for example, an augmented reality online game (ARG) with location-aware capabilities in a still trusted, confidential and convenient manner. But before doing that, such software 416 had to be trusted by the person 405 and his friends 404 inside the digital environment.

For business purposes, the software solution 417 is, for example, a third-party field sales software solution that has been first trusted by the company 406. After that, the company has sent an invitation to its employees (405 and 407) who then have accepted it (trusted it). With such trust by the company and its employees, now the software 417 can properly handle the employees' sensitive information (such as their current location) and, then, automate valuable business scenarios without violating their privacy. This is possible, obviously, due to the role of the present invention as a trust and confidentiality intermediate for users and organizations. A similar chain of trust happens among the delivery company 412, its deliveryman 413 and the third-party real-time delivery tracking software solution 418.

For public purposes, the present invention is the proprietary software solution itself, which means, it is the very trusted digital environment 403 wherein all participants (being individuals, organizations or third-party software solutions) are registered and share their public interfaces (transactions) with each other. Please note that the trust chain among the company 406, its employees (405 and 407), the field sales software solution 417, the delivery company 412, its deliveryman 413 and the deliver tracking software solution 418 allows the person 405 to know where the person 413 is in real-time, that is, it allows the vendor to know where the goods he just sold is and when it is going to be delivered by the deliveryman 413, for example. Another possible scenario that is likely to happen is the emergency service 408, its official 409, the security company 410, its attendant 409 and the coworker 407, all could be aware of person's 405 sensitive information (including his real-time location) during a distress situation for which he has called private panic. All in the trust chain could answer to that private panic (as stated in the application Ser. No. 13/208,710).

Nowadays, no mobile platform, operating system or social network has, as the present invention does, the capacity of acting as a trust and confidentiality intermediate for users and organizations in personal, professional and public affairs.

For instance, every time a user installs a location-aware mobile application into his smartphone, he has to give it plenty authorization for his location tracking regardless what he is doing. The only current way he can, for example, surely avoid a field sales software solution, as above exemplified, to monitor him even while he is resting at home is to turn-off the location-tracking capabilities of his smartphone. But doing so, he also loses the location-aware capabilities of any application or services for personal or public use (including such critical ones described by the application U.S. Ser. No. 13/208,710).

On top of trust relationships among persons, organizations and software—trust relationships of various types such as solidary reputation 404 & 405, employment 405 & 406, co-working 405 & 407, protection 405 & 410 & 408, service providing 406 & 412 and so on—the present invention can then provide actual sharing and protection of information based on the activities (and corresponding transactions) performed inside its trusted digital environment.

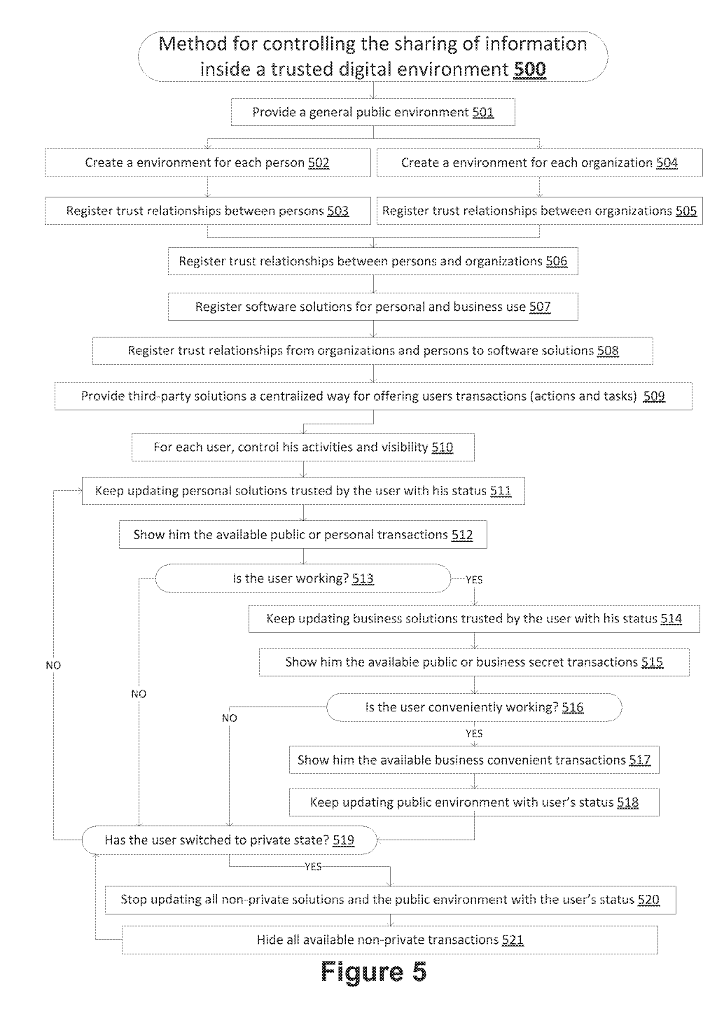

FIG. 5 depicts a method 500 for controlling the sharing of information inside the trusted digital environment on an activity-based manner which, in turn, gives to users' privacy primacy over any other demand or transaction. Such method 500 is automated by web services and mobile applications running in modern mobile devices (e.g. smartphones).

As doing so, the present invention actually behaves as its users' trust and confidentiality intermediate. Accordingly, it first provides a general trusted public environment widely available via the Internet 501, which is responsible for being the trusted public channel among all registered participants in order share their public interfaces, as above stated.

Next, the present invention provides a personal environment particular to each registered person (or user) 502 and, then, register the trust relationships of many kinds between persons 503, including but not limited to the solidary reputation as above stated. The present invention also includes a trusted business environment particular to each registered organization 504, also registering the trust relationships between organizations 505 for various purposes such as the ones above cited. After that, the present invention registers the trust relationships of many kinds between persons and organizations 506, including but not limited to employment relationships as above stated.

Having persons and organizations registered and related to each other, the present invention then register the third-party software solutions (applications and services) likely to be offered to individuals and organizations 507, as well as the trust (and interest) of organizations and persons in sharing their information with said solutions 508.

Please note that, as above stated, at step 508, the trust relationships between organizations and persons, in particular, but not limited to the employment relationships, are used for setting up and sharing a trust relationship among a given third-party software solution, a given organization and the persons who trust them both. So such relationships are first defined by the organization trusting said solution and then by the organization sending its trusted related persons an invitation also to trust said solution. When the trusted related persons accept the invitation (trust said solution) they are actually giving said solution permission to know the trust relationships they have with said organization. Consequently, said solution can now handle user's private information for business purposes.

In order to act as a user's trust and confidentiality intermediate, the present invention provides any third-party software solution registered and user trusted a centralized way for offering him transactions 509, both spontaneous (actions) and prescribed (tasks). This centralized transaction offering has classifications for actions and tasks according to said six types of transactions, namely professional secret, professional convenient, personal private, personal collaborative, public reckoned and public anonymous. Thus, every action or task transaction from third-party solutions or from the present invention itself is mandatorily marked as from one of said types. So, it is properly managed both by the present invention and its very user as stated bellow.

Besides offering the user better usability and control over what he can and wants to do in the trusted pervasive environment, said centralized transaction offering is actually the means by which the present invention intermediate trust and confidentiality between the user and the solutions serving him. Kindly note that personal solutions can only offer to the user transactions of personal (private and collaborative) and public (reckoned and anonymous) types, as well as business solutions can only offer him transactions of business (secret and convenient) and public (reckoned and anonymous) types. Therefore, this step 509 is central for the proper use of said chain of trust, since the present invention is the one which has the premise to control where (that is, the location), when, how and with which third-party software solution the user's information will be shared.

Conversely, the present invention is always assuring any registered third-party software solution that a trusted reckoned user is using (transacting with) it, as above stated. This remains true even in anonymous transactions, for example: after a sales has being done, the above stated third-party field sales software solution could send the final customer (the user who had electronically bought from salesman) an opinion survey that could then be answered anonymously through a public anonymous task—in this case, the present invention would keep the user's identity closed to said solution. Yet, any user's abuse could be tracked back and properly handled by the present invention, as above stated.

Another fundamental aspect of the intermediation of the user's trust and confidentiality is the way he electronically relates to his employing organization. As above cited, currently there is no effective general control for prohibiting a business application running in a personal device such as a smartphone from entering user's private live when that is the case. Neither there is any effective general control for prohibiting a personal application from disturbing the user when he needs isolation. In order to provide that, the present invention controls the activities and visibility of each user 510 on top of said centralized transaction offering and also based on each user's current activities and states. Considering that the user is in normal state (applying the same principles of the states described in the applications U.S. Ser. No. 13/208,710), all third-party personal solutions trusted by him are regularly kept updated by the present invention with his current status 511 (including his location). The present invention then presents the user any available personal transactions (actions and tasks of said public and personal types only) from said solutions 512 so that he can interact with them. Together, the steps 511 and 512 give said solutions the trusted channel and all the contextual information about the user needed for effectively transacting with him in a valuable, trusted and confidential manner. For example, the automatic Foursquare check-in as above conjectured could be easily and properly done if Foursquare were a registered third-party personal solution trusted by the user.

Next, the present invention asks the user to report whether he is working 513. This can be done by a simple graphical control that switches to true or false (working or not-working, respectively) or by a recurring schedule of the days and periods of time he actually works—with precedency of said graphical control over said recurring schedule. If he is working, the present invention keeps updating with his status all third-party business solutions trusted by him 514 and presents him any available transactions (actions and tasks of said public and professional secret types only) from said solutions 515, also giving to them trusted channel and all the contextual information about the user needed for properly transacting with him.

Then, the present invention asks the user to report if he is working conveniently (as above stated), that is, it asks the user to select from a graphical control the type of professional transactions between secret and convenient or by a recurring schedule of the days and periods of time he actually works conveniently 516—with precedency of said graphical control over said recurring schedule. If he is working conveniently, the present invention presents him any available convenient transactions (actions and tasks of said convenient business type only) from said business solutions 517 and keeps said public environment updated with his live status (including his location) 518. This properly allows any user of the present invention knowing who is currently providing convenient services nearby—such as the cab example above cited.

If the user is in private state 519 (as stated in said U.S. related application U.S. Ser. No. 13/208,710) then, the present invention stops updating with the user's status any trusted third-party software solutions that has no open private transactions (i.e. private actions or private tasks that are yet to be completed) and the public environment 520, as well as it hides from the user all available transactions of types other than private 521.

Besides conveniently preserving the user's privacy, the step 515 (conditioned on the step 513) and step 521 are actually a fundamental way of ensuring that the user is not doing business transactions when not working and, so, adds greatly to said role as user's intermediate regarding trust and confidentiality: likewise the present invention ensures its users that no third-party business solution has invaded his privacy, it gives organizations (and labor authorities) control over whether business activities are being done by their employees outside organizations' facilities.

Obviously, in order to preserve the benefits of said intermediation (on the three scenarios: personal, professional/business and public), the third-party software solutions must rather stop asking special monitoring authorizations on personal devices such as smartphones (e.g. asking permanent authorization inside Android Operating System for reading and publishing user's position). This is indeed a matter of adoption curve, that is, a market movement toward a safe, trusted and confidential direction. However, there must be a general infrastructure such as the present invention so that this movement can happen. And those of ordinary skill in the art will promptly appreciate that such market adoption curve does not diminish at all any attribute of the present invention.

Acting itself as a third-party personal and business software solution always trusted by its users and organizations, the present invention has built-in functionalities that can only be properly offered to users (trustily and confidentially) thanks to all its capabilities above stated.

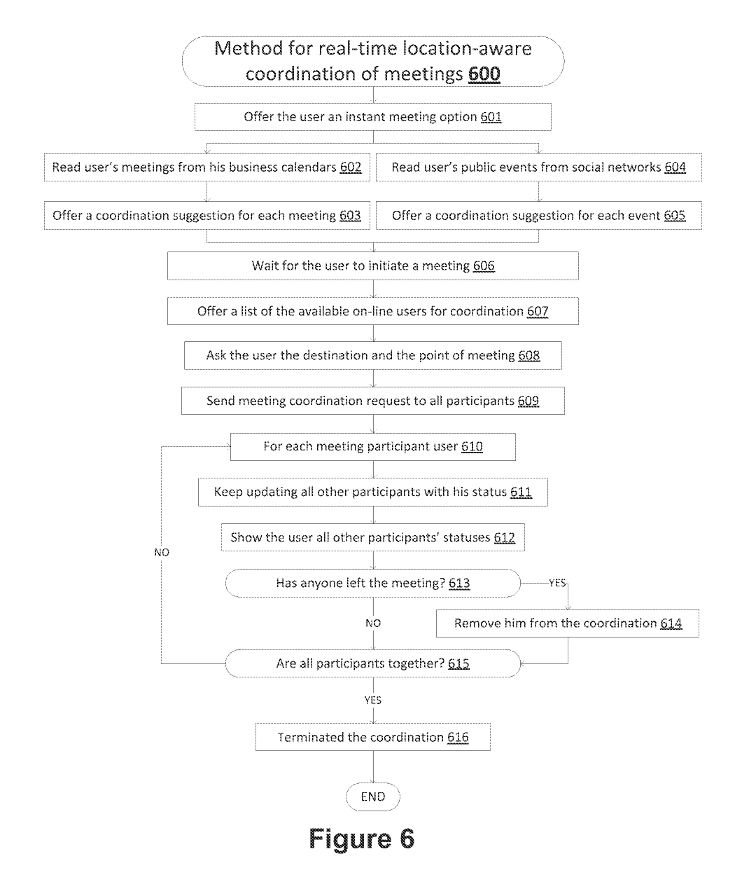

FIG. 6 depicts a method 600 for providing real-time location-aware coordination of meetings between users for personal, professional or public interests, which is automated by web services and mobile applications running in modern mobile devices (e.g. smartphones).

The invention starts offering a transaction for instant meeting 601. This transaction is offered through said centralized transaction offering and it is actually an action (of said personal collaborative type of transaction), that is, it is an option offered to the user for his spontaneous triggering when he is not in private state (as stated in said US related application U.S. Ser. No. 13/208,710).

In order to proactively help the user doing his meeting coordination, the present invention first integrates and reads his synchronized mobile business calendars 602 (e.g. the calendar of Microsoft Exchange synchronized with the calendar of the user's iPhone) and, then, creates a coordination suggestion (i.e., a convenient type task transaction which is then showed up to the user in order to remind him to do it) for each near future appointment in said calendars that are likely to happen far from any participant's current location 603. The invention also integrates with the social networks that the user takes part in order to read the public events the user is going to attend 604. Then, its is created a coordination suggestion as a reckoned type task transaction for each coming event 605.

After doing that, the present invention has three sources for starting a real-time location-aware meeting coordination for the user: a spontaneous instant meeting action and the programmed meetings tasks for business meetings and public events—all of them available to the user through said centralized transaction offering. Having that, the present invention waits for the user to initiate one of them 606.

Depending on the type and origin of the started coordination, the present invention suggests the participants for that meeting from the users (even the users that are not trusted by said users) who have on-line status 607. For example, a business meeting the user has with a person (actually a user of the present invention, but not known by him) can be coordinated between them both because of the contextual permission implicit in such meeting.

After having all possible participating candidates, the present invention then asks the user the final destination of the coordination (i.e. the location where all participants are going) and the meeting point (i.e. the location where all participants are going to meet) 608. It should be noted that the present invention offers the users a valuable distinction between those two locations, so the meeting point could be either a static place (e.g. a restaurant) or any participant's current location (e.g. everybody follows John through the restaurant).

All this is possible thanks to the activity-based visibility control the present invention has, as above stated. For that matter, a meeting coordination request (as a task transaction) is sent to each entered participating candidates 609.

After a user has accepted said coordination request, the present invention starts to coordinate him with the others 610, by sending his status to the others 611 and sending theirs status to him 612 (obviously, if-and-only-if he is in normal state as above stated). If any participant rather wants to leave the meeting 613, then the present invention stops sharing his status with the others and vice-versa 614. Otherwise, the coordination is kept live until all participants are close by a given distance 615 (e.g. 30 feet), when all status sharing stops completely 616. Of course, if there is only one participant left, the coordination automatically stops.

The present invention also provides third-party trusted software solutions with the same meeting coordination capabilities by allowing them to offer to users meeting transactions (actions and tasks) for many purposes. These transactions will then be initiated by the user in the step 606 in the same way he initiates the transactions as in 601, 603 and 605. For instance, said field sales software solution could offer general users a “send me a sales rep” action for calling any salesman who is nearby and in said convenient state. Another example, said delivery tracking software solution could offer to the user who bought from said salesman a “deliver me here my goods” task for real-time coordination of the delivery by said deliveryman to users current location.

By doing such real-time context-aware coordination of meetings of many types, as above stated, the present invention provides its users (and its software solution partners) a unique and unmatched capability that was already expected to be offered by other providers, considering the powerful technological resources widely available these days. But this is not a matter of technical capacity, it is rather a typical pervasive computing scenario that has its roots in a reliable control of trust and confidentiality for general social use such as the present invention.

The many features and advantages of the present invention are apparent from the written description, and thus, it is intended by the appended claims to cover all such features and advantages of the invention.

Although the concepts disclosed herein have been described in connection with the preferred form of practicing them and modifications thereto, those of ordinary skill in the art will understand that many other modifications can be made thereto within the scope of the claims that follow.

Accordingly, it is not intended that the scope of these concepts in any way be limited by the above description, but instead be determined entirely by reference to the claims that follow.

1. A method for building a solidary personal reputation for public transactions inside a trusted digital environment, said method comprising a web service for:
registering individuals as users and asking them to inform other users trusted by them who also trust them;
sending to every informed trusted user a solidary trust request from the sender user so as to set up a solidary reputation agreement between him and the user who has accepted the request;
defining a minimal number of solidary reputation trusted friends a user must have in order to publically transact inside said trusted digital environment;
defining a minimal number of trust grade points a user must have in order to publically transact inside said trusted digital environment;
checking if the each user has said minimal number of solidary reputation trusted friends and, if positive, give him a given number of trust grade points bigger than said minimal number of trust grade points; and
authorizing the user to perform public transactions inside said trusted digital environment.

2. A method as in claim 1, wherein, for each public transaction a trusted user performs inside said trusted digital environment, said method comprising said web service for:
waiting for reports from trusted users regarding said public transaction;
adding one grade point to current trust grade points of the user who performed said public transaction if said report is positive;
subtracting one grade point to current trust grade points of the user who performed said public transaction if said report is negative;
limiting said new current trust grade points to both a giving minimal points limit and a giving maximal points limit;
putting the user who performed said public transaction in quarantine state if his said new current trust grade points are lower than said minimal number of trust grade points;
prohibiting said user in quarantine state from performing public transactions inside said trusted digital environment; and
removing said user from quarantine state after a given period of time, thus setting his trust grade to said minimal number of trust grade points, as well as authorizing him again to perform public transactions inside said trusted digital environment.

3. A method as in claim 1, wherein, for each public transaction a trusted user performs inside said trusted digital environment, said method comprising said web service for:
waiting for reports from trusted users regarding said public transaction;
adding half grade point to current trust grade points of all users in the solidary reputation agreement with the user who performed said public transaction if said report is positive;
subtracting half grade point to current trust grade points of all users in the solidary reputation agreement with the user who performed said public transaction if said report is negative;
limiting said new current trust grade points to both a giving minimal points limit and a giving maximal points limit;
putting said solidary users in quarantine state if their new current trust grade points are lower than said minimal number of trust grade points;
prohibiting said solidary users in quarantine state from performing public transactions inside said trusted digital environment; and
removing said solidary users from quarantine state after a given period of time, thus setting their trust grade to said minimal number of trust grade points, as well as authorizing them again to perform public transactions inside said trusted digital environment.

4. A method for controlling the sharing of information inside a trusted digital environment, said method comprising web services for:
providing a general public environment for reckoned or anonymous public transactions among all participants;
providing a personal environment particular and private to each individual user registered;
registering trust relationships between said registered users;
providing a business environment particular and private to each registered organization;
registering trust relationships between said registered organizations;
registering trust relationships between a said registered user and a said registered organization;
registering software solutions for personal use thus making them available to said registered users;
registering trust relationships between a said registered user and a said registered personal software solution thus allowing said solution to access said users' confidential information;
registering software solutions for business use thus making them available to said registered organizations;
registering trust relationships between a said registered organization and a said registered business software solution thus allowing said solution to send to registered users who trust said registered organization a trust request; and
registering relationships between said registered business software solutions and the users who accepted their said trusted requests, thus allowing said solutions to access said users confidential information.

5. A method as in claim 4, wherein said trust relationships between said registered users are of many types, including but not limited to said solidary reputation agreements.

6. A method as in claim 4, wherein said trust relationships between said registered organizations are of many types, including but not limited to service providing relationships.

7. A method as in claim 4, wherein said trust relationships between a said registered user and a said registered organization are of many types, including but not limited to employment relationships.

8. A method as in claim 4, wherein for each said software solution for personal use, said method comprising said web services and mobile application for:
reserving in each registered user's said personal digital environment a dialog space for said personal software solution to publish its action transactions for spontaneous initiation by said registered user; and
reserving in each registered user's said personal digital environment a dialog space for said personal software solution to publish its task transactions for notification of said registered user and its initiation and completion by him.

9. A method as in claim 8, wherein said action transactions are of said types personal private, personal collaborative, public reckoned and public anonymous.

10. A method as in claim 8, wherein said task transactions are of said types personal private, personal collaborative, public reckoned and public anonymous.

11. A method as in claim 4, wherein, for each said software solution for business use, said method comprising said web services and mobile application for:
reserving in each registered user's said personal digital environment a dialog space for said business software solution to publish its action transactions for spontaneous initiation by said registered user; and
reserving in each registered user's said personal digital environment a dialog space for said business software solution to publish its task transactions for notification of said registered user and its initiation and completion by him.

12. A method as in claim 11, wherein said action transactions are of said types professional secret, professional convenient, public reckoned and public anonymous.

13. A method as in claim 11, wherein said task transactions are of said types professional secret, professional convenient, public reckoned and public anonymous.

14. A method as in claim 4, wherein, for each said registered user in said normal state only, said method comprising said web services and said mobile application for:
updating on regular basis each said personal solution trusted by said registered user with his status;
showing said registered user said actions and said tasks said trusted personal solution makes available to him;
asking said registered user to inform whether he is in working sub-state of normal state, said sub-state captured by the means of a true-or-false graphical control or a recurring schedule of working days and time functionality, both offered to said registered user but said graphical control having precedency over said recurring schedule;
updating on regular basis each said business solution trusted by said registered user with his status, if-and-only-if he is in working sub-state of normal state;
showing said registered user, if-and-only-if he is in working sub-state of normal state, said actions and said tasks of public reckoned, public anonymous and professional secret types said trusted business solution makes available to him;
asking said registered user to inform whether he is in convenient sub-state of working sub-state of normal sub-state, such convenient sub-state captured by the means of a true-or-false graphical control or a recurring schedule of convenient working days and time functionality, both offered to said registered user but said graphical control having precedency over said recurring schedule;
showing said registered user, if-and-only-if he is in convenient sub-state of working sub-state of normal state, said actions and said tasks of professional convenient types said trusted business solution makes available to him; and
updating on regular basis said public digital environment with said registered user's status if-and-only-if he is in said convenient sub-state of working sub-state of normal state.

15. A method as in claim 4, wherein for each said registered user in said private state, said method comprising said web services and said mobile application for:
stopping updating on regular basis with said user's status all said business solutions, as well as said personal solutions which has neither private action transactions nor pending private task transactions;
stopping updating on regular basis said public environment with said user's status; and
hiding all said transactions available to said users that are of transaction types other than said personal private.

16. A method real-time location-aware coordination of meetings between users for personal, professional or public affairs, said method comprising said web services and said mobile application for:
offering each registered user an instant meeting action transaction of said personal collaborative type in said dialog space inside said personal digital environment so the user can spontaneously initiate said meeting coordination;
reading said registered user's mobile business calendar facility in order to offer him meeting coordination suggestion as task transactions of said professional convenient type for each coming appointment likely to happen far from any participant's current location;
reading said registered user's social network profiles in order to offer him meeting coordination suggestion as task transactions of said public reckoned type for each coming public event he is going to attend;
waiting for said registered user initiating a meeting coordination from the three said origins;
offering said registered user a list of potential participants in said coordination from on-line registered users of said original appointment or event or from any registered on-line user known by him;
asking said registered user to inform the final destination location, as well as the halfway metting location or which said potential participant whose current location all other participants will first meet at, before going to said final destination location; and
sending to each said potential participant informed by said registered user coordination request and adding him into said coordination if he has approved it.

17. A method as in claim 16, wherein for each said coordination participant user who is only in said normal state or in its sub-states, said method comprising said web services and said mobile application for:
keeping all other coordination participants updated on regular basis with said participant user's status;
keeping said participant user updated on regular basis with said all other coordination participants statuses;
removing from said coordination any participant requesting for doing so; and
terminating the coordination if all participants are close by a given distance or if said coordination has only one participant left.

18. A method as in claim 16, wherein terminating the coordination includes updating all the status among participants.

19. A method as in claim 16, wherein any said trusted third-party software solution can offer to said user a coordination meeting action or task in order to be initiated by him, being coordinated with all participants.
